(19) United States
(12) Patent Application Publication
(10) Pub. No.: US 2022/0342991 A1
(43) Pub. Date: Oct. 27, 2022

(54) ELECTRONIC MAIL DECRYPTING DEVICE, ELECTRONIC MAIL DECRYPTING METHOD, AND NON-TRANSITORY COMPUTER READABLE MEDIUM STORING PROGRAM

(71) Applicant: NEC Corporation, Minato-ku, Tokyo (JP)

(72) Inventor: Teruaki SASOU, Tokyo (JP)

(73) Assignee: NEC Corporation, Minato-ku, Tokyo (JP)

(21) Appl. No.: 17/642,397

(22) PCT Filed: Jul. 20, 2020
(86) PCT No.: PCT/JP2020/028014

§ 371 Date: Mar. 11, 2022

(30) Foreign Application Priority Data
Sep. 18, 2019 (JP) 2019-169336

(51) Int. Cl. G06F 21/56; G06F 21/60; H04L 51/08

(52) U.S. Cl. CPC G06F 21/566; G06F 21/602; H04L 51/08

(57) ABSTRACT

An electronic mail decrypting device includes a password candidate extracting unit configured to extract a character string to serve as a password candidate from a text body of an electronic mail; a storing processing unit configured to perform a process of storing the password candidate and attribute information of the electronic mail from which the password candidate has been extracted with the password candidate and the attribute information associated with each other; a password estimating unit configured to estimate a password to be used to decrypt an encrypted file based on attribute information of an electronic mail having the encrypted file attached thereto as well as the stored password candidate and the stored attribute information of the electronic mail from which the password candidate has been extracted; and a decryption processing unit configured to perform a process of decrypting the file by use of the estimated password.

### TECHNICAL FIELD

The present invention relates to electronic mail decrypting devices, electronic mail decrypting methods, and programs and relates, for example, to a technique for automatically decrypting an encrypted file attached to an electronic mail.

### BACKGROUND ART

When an encrypted file attached to an electronic mail is, for example, inspected or quarantined, this file needs to be decrypted. The following are some of the decryption methods employed in systems.

In a first method, a password is set in advance in a system, and an encrypted email is decrypted automatically with the set password. In this case, however, passwords associated with senders or recipients need to be set in advance in the system, and this makes it hard to manage the system.

In a second method, with the precondition that a sender sends a password after sending an encrypted email, the encryption of the email is lifted automatically. In this case, however, the password needs to be sent after the encrypted email, and this places a constraint on the condition where automatic decryption is possible.

In one related technique, Patent Literature 1 discloses a distribution controlling device such as the one described below. This distribution controlling device searches for a ticket that includes, as ticket information, a sender and recipient pair of an email. Then, the distribution controlling device acquires, from a key database, an encryption key to be paired with the ticket ID of the ticket and decrypts a file attached to the email by use of the acquired encryption key.

Meanwhile, Patent Literature 2 discloses an encryption controlling device such as the one described below. This encryption controlling device stores a password for an encrypted file as well as the sender and the addressee of the past electronic mail having this encrypted file attached thereto and encrypts, by use of the stored password, a file attached to another electronic mail having the same sender and addressee pair.

### CITATION LIST

### Patent Literature

Patent Literature 1: Japanese Unexamined Patent Application Publication No. 2019-057234
Patent Literature 2: Japanese Unexamined Patent Application Publication No. 2017-135617

### SUMMARY OF INVENTION

### Technical Problem

According to the technique disclosed in Patent Literature 1, practically, the distribution controlling device generates an encryption key, and thus an attached file encrypted with an unknown password cannot be decrypted automatically. Meanwhile, according to the technique disclosed in Patent Literature 2, passwords stored in the encryption controlling device are the ones that a user or users have entered into the encryption controlling device. Therefore, in this case either, an attached file encrypted with an unknown password cannot be decrypted automatically.

Accordingly, one of the objects to be achieved by example embodiments disclosed in the present specification is to provide an electronic mail decrypting device, an electronic mail decrypting method, and a program that can decrypt an encrypted file attached to an electronic mail with reduced operational constraints.

### Solution to Problem

An electronic mail decrypting device according to a first aspect includes:

password candidate extracting means configured to extract a character string to serve as a password candidate from a text body of an electronic mail;

storing processing means configured to perform a process of storing the password candidate and attribute information of the electronic mail from which the password candidate has been extracted with the password candidate and the attribute information associated with each other;

password estimating means configured to estimate a password to be used to decrypt an encrypted file based on attribute information of an electronic mail having the encrypted file attached thereto as well as the stored password candidate and the stored attribute information of the electronic mail from which the password candidate has been extracted; and

decryption processing means configured to perform a process of decrypting the file by use of the estimated password.

An electronic mail decrypting method according to a second aspect includes:

extracting a character string to serve as a password candidate from a text body of an electronic mail;

performing a process of storing the password candidate and attribute information of the electronic mail from which the password candidate has been extracted with the password candidate and the attribute information associated with each other;

estimating a password to be used to decrypt an encrypted file based on attribute information of an electronic mail having the encrypted file attached thereto as well as the stored password candidate and the stored attribute information of the electronic mail from which the password candidate has been extracted; and

performing a process of decrypting the file by use of the estimated password.

A program according to a third aspect causes a computer to execute:

a password candidate extracting step of extracting a character string to serve as a password candidate from a text body of an electronic mail;

a storing processing step of performing a process of storing the password candidate and attribute information of the electronic mail from which the password candidate has been extracted with the password candidate and the attribute information associated with each other;

a password estimating step of estimating a password to be used to decrypt an encrypted file based on attribute information of an electronic mail having the encrypted file attached thereto as well as the stored password candidate and the stored attribute information of the electronic mail from which the password candidate has been extracted; and

a decryption processing step of performing a process of decrypting the file by use of the estimated password.

### Advantageous Effects of Invention

The above aspects can provide an electronic mail decrypting device, an electronic mail decrypting method, and a program that can decrypt an encrypted file attached to an electronic mail with reduced operational constraints.

### BRIEF DESCRIPTION OF DRAWINGS

FIG. 1 is a block diagram illustrating an example of a configuration of an electronic mail decrypting device according to an overview of example embodiments.

FIG. 2 illustrates an example of an encrypted email and an email containing a password.

FIG. 3 is a block diagram illustrating an example of a configuration of an electronic mail decrypting device according to a first example embodiment.

FIG. 4 is a table for describing the counting of the number of appearances.

FIG. 5 is a general illustration showing an example of password association information stored in a password candidate storing unit.

FIG. 6 is a general illustration showing another example of password association information stored in a password candidate storing unit.

FIG. 7 illustrates an example of emails to be associated with each other by email identification information.

FIG. 8 is an illustration for describing how a password is estimated based on a success record.

FIG. 9 is an illustration for describing how a password is estimated with a correction made on a stored password candidate.

FIG. 10 is a schematic diagram illustrating an example of a hardware configuration of an electronic mail decrypting device according to an example embodiment.

FIG. 11 is a flowchart for describing a flow of an operation performed when an electronic mail decrypting device according to an example embodiment extracts a password candidate from an electronic mail.

FIG. 12 is a flowchart for describing a flow of an operation performed when the electronic mail decrypting device according to the first example embodiment decrypts an encrypted email.

FIG. 13 is a block diagram illustrating an example of a configuration of an electronic mail decrypting device according to a second example embodiment.

FIG. 14 is a flowchart for describing a flow of an operation performed when the electronic mail decrypting device according to the second example embodiment decrypts an encrypted email.

FIG. 15 is a block diagram illustrating an example of a configuration of an electronic mail decrypting device according to a third example embodiment.

### DESCRIPTION OF EMBODIMENTS

### Overview of Example Embodiments

An overview of example embodiments will be given prior to describing the example embodiments in detail.

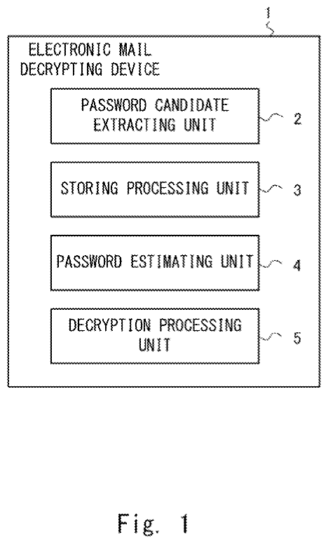

FIG. 1 is a block diagram illustrating an example of a configuration of an electronic mail decrypting device 1 according to an overview of example embodiments. As illustrated in FIG. 1, the electronic mail decrypting device 1 includes a password candidate extracting unit 2, a storing processing unit 3, a password estimating unit 4, and a decryption processing unit 5.

The password candidate extracting unit 2 extracts a character string to serve as a password candidate from a text body of an electronic mail. For example, the password candidate extracting unit 2 may perform a process of extracting a character string that serves as a password candidate from every electronic mail that the electronic mail decrypting device 1 receives or may perform this extracting process only on electronic mails with no file attached thereto.

The storing processing unit 3 performs a process of storing a password candidate extracted by the password candidate extracting unit 2 and attribute information of the electronic mail from which this password candidate has been extracted with the password candidate and the attribute information associated with each other. The storing processing unit 3 stores password candidates and attribute information, for example, into a storage device included in the electronic mail decrypting device 1. Alternatively, the storing processing unit 3 may store password candidates and attribute information into another device connected to and capable of communicating with the electronic mail decrypting device 1.

The password estimating unit 4 estimates a password to be used to decrypt an encrypted file attached to an electronic mail. The password estimating unit 4 estimates a password based on attribute information of an electronic mail to which an encrypted file is attached as well as a password candidate stored through the process of the storing processing unit 3 and attribute information of an electronic mail from which this password candidate has been extracted.

The decryption processing unit 5 performs a process of decrypting an encrypted file by use of a password estimated by the password estimating unit 4.

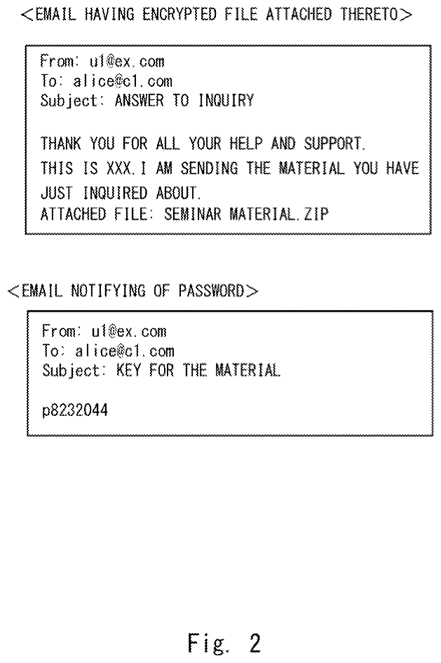

In this manner, the electronic mail decrypting device 1 accumulates password candidates extracted from the text body of electronic mails with the password candidates associated with attribute information of the electronic mails from which the password candidates have been extracted. Then, a password is estimated from the password candidates with the aid of attribute information of an electronic mail to which the encrypted file is attached. The file is then decrypted with this estimated password. Typically, when an electronic mail is sent with an encrypted file attached thereto, a password is sent in another electronic mail separate from the electronic mail with the attachment, as illustrated in FIG. 2. The electronic mail decrypting device 1 can automatically decrypt a file even in an environment where such a typical operation is adopted. Accordingly, the electronic mail decrypting device 1 can decrypt an encrypted file attached to an electronic mail with reduced operational constraints.

Now, some example embodiments will be described in detail.

### First Example Embodiment

First, a first example embodiment will be described.

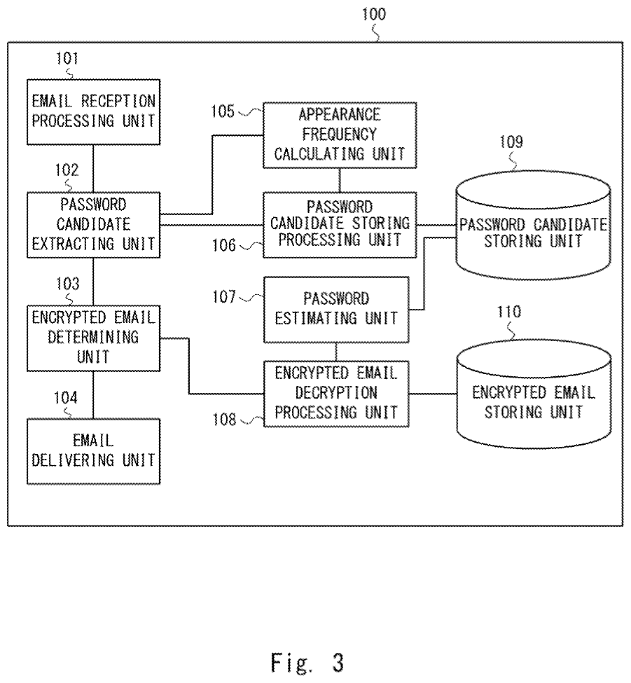

FIG. 3 is a block diagram illustrating an example of a configuration of an electronic mail decrypting device 100 according to the first example embodiment. The electronic mail decrypting device 100 is used, for example, in an electronic mail system. Preferably, the electronic mail decrypting device 100 is used in a system on the receiving side of emails (e.g., in an email server on the receiving side).

The electronic mail decrypting device 100 receives an electronic mail sent from a sender and delivers this electronic mail to its addressee. At this point, the electronic mail decrypting device 100 performs a decrypting process on an encrypted file. This configuration makes it possible to perform a check such as inspection or quarantine, for example. Now, the electronic mail decrypting device 100 according to an example embodiment will be described in more concrete terms.

The electronic mail decrypting device 100 includes an email reception processing unit 101. The email reception processing unit 101 performs a process of receiving an electronic mail. The email reception processing unit 101 performs this receiving process in accordance with, for example, Simple Mail Transfer Protocol (SMTP).

The electronic mail decrypting device 100 includes a password candidate extracting unit 102. The password candidate extracting unit 102 corresponds to the password candidate extracting unit 2 illustrated in FIG. 1. The password candidate extracting unit 102 extracts a character string that is contained in a text body of an electronic mail received by the email reception processing unit 101 and that can be a password (i.e., a character string to serve as a password candidate).

For example, the password candidate extracting unit 102 scans the text body of an email and extracts consecutive ASCII codes. In other words, the password candidate extracting unit 102 extracts a character string consisting of alphanumerics or symbols. A rationale for performing such an extraction is that, typically, a character string consisting of alphanumerics or symbols is used for a password. Such an extraction, however, is not a limiting example, and the password candidate extracting unit 102 may extract a password candidate in accordance with any other known predetermined extraction rules.

The electronic mail decrypting device 100 includes an encrypted email determining unit 103. The encrypted email determining unit 103 determines whether an electronic mail received by the email reception processing unit 101 has an encrypted file attached thereto. In the following description, an electronic mail having an encrypted file attached thereto is referred to as an encrypted email.

As described above, the encrypted email determining unit 103 determines whether an electronic mail received by the email reception processing unit 101 includes an encrypted attached file. Specifically, for a compressed file, such as a zip file or a 7z file, for example, the encrypted email determining unit 103 checks whether such a file can be extracted without a password and thus checks whether the attached file is an encrypted file. Meanwhile, for a password-protected executable file, for example, the encrypted email determining unit 103 checks whether such a file can be executed without a password and thus checks whether the attached file is an encrypted file. The method of checking is not limited to the ones described above, and the encrypted email determining unit 103 may check whether an attached file is an encrypted file in accordance with any other known predetermined checking rules.

An encrypted email needs a decrypting process. Therefore, the encrypted email determining unit 103 stores an encrypted email into an encrypted email storing unit 110.

The electronic mail decrypting device 100 includes an email delivery processing unit 104. The email delivery processing unit 104 performs a process of delivering an electronic mail received by the email reception processing unit 101 to the addressee of this electronic mail. The email delivery processing unit 104 delivers an electronic mail to its addressee in accordance with SMTP, for example. The email delivery processing unit 104 delivers an email based on email information (the email header) of the electronic mail received by the email reception processing unit 101.

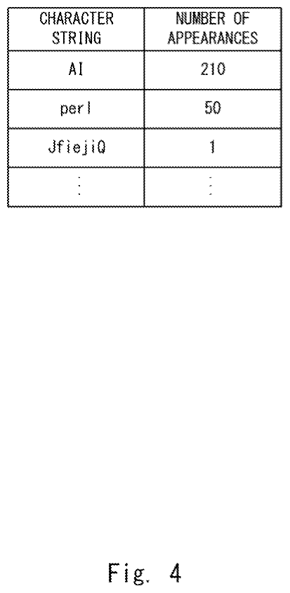

The electronic mail decrypting device 100 includes an appearance frequency calculating unit 105. The appearance frequency calculating unit 105 calculates the appearance frequency of each password candidate. The appearance frequency calculating unit 105 calculates the appearance frequency based, for example, on how many times a given password candidate has appeared in all the electronic mails received by the email reception processing unit 101. For this purpose, the appearance frequency calculating unit 105 counts the number of appearances of each character string, as illustrated in FIG. 4. The appearance frequency calculating unit 105 may, for example, calculate a ratio where the denominator is the sum total of the numbers of appearances of all the character strings and the numerator is the number of appearances of a certain character string of which the appearance frequency is to be calculated, and may use this ratio as the appearance frequency of the character string of which the appearance frequency is to be calculated. Typically, a character string used as a password is not a character string that is used frequently. Therefore, the appearance frequency serves as a factor for determining whether a given password candidate is actually a password.

The electronic mail decrypting device 100 includes a password candidate storing processing unit 106. The password candidate storing processing unit 106 corresponds to the storing processing unit 3 illustrated in FIG. 1. The password candidate storing processing unit 106 performs a process of storing, into a password candidate storing unit 109, a password candidate extracted by the password candidate extracting unit 102 and attribute information of an electronic mail from which this password candidate has been extracted with the password candidate and the attribute information associated with each other. In this example, attribute information refers specifically to the sender information, the addressee information, and the receiving time of an electronic mail. The receiving time is the time at which the email reception processing unit 101 (the electronic mail decrypting device 100) has received the electronic mail.

According to the present example embodiment, the password candidate storing processing unit 106 further performs a process of storing the appearance frequency calculated by the appearance frequency calculating unit 105 with the appearance frequency associated with the corresponding password candidate. Moreover, the password candidate storing processing unit 106 further performs a process of storing a success record of decryption involving a certain password candidate with the success record associated with this password candidate. Specifically, the password candidate storing processing unit 106 performs a process of storing the number of times decryption involving a certain password candidate has succeeded on different files.

In the following description, a password candidate and information associated with this password candidate will be referred to as password association information.

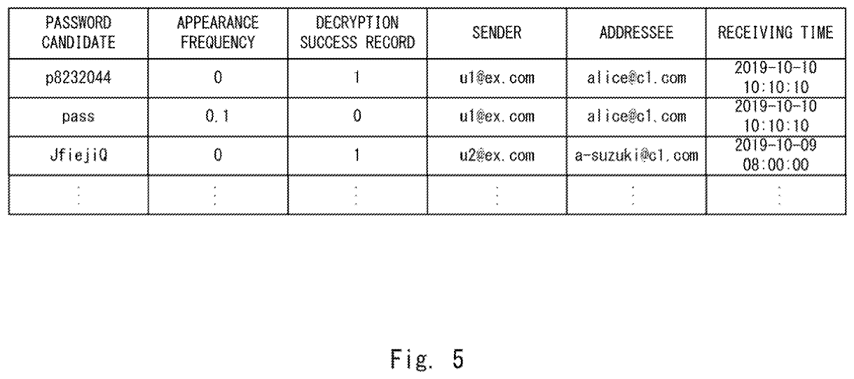

FIG. 5 is a general illustration showing an example of password association information stored in the password candidate storing unit 109. As illustrated in FIG. 5, the password association information includes the password candidates, the appearance frequencies, the decryption success records, the sender information, the addressee information, and the receiving times.

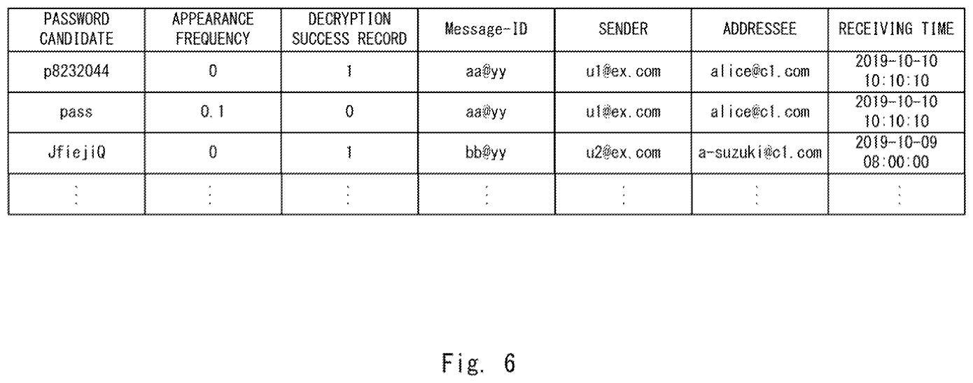

In this example, the password candidate storing processing unit 106 may further perform a process of storing email identification information (specifically, Message-ID) of an electronic mail from which a given password candidate has been extracted with the email identification information associated with this password candidate. FIG. 6 illustrates an example of password association information to be stored into the password candidate storing unit 109 in that case.

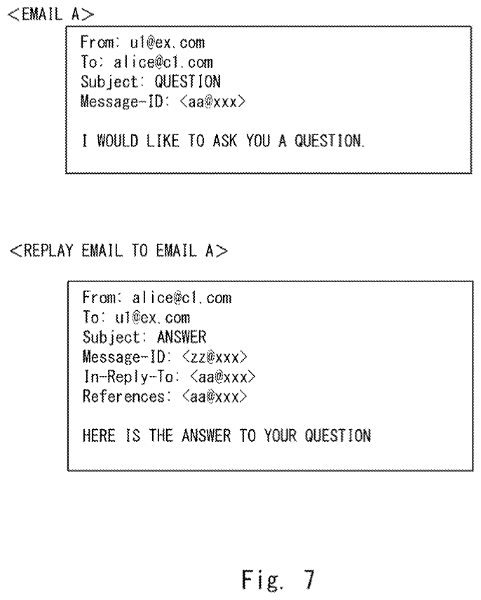

As illustrated in FIG. 7, “References” in the email header contains “Message-ID” of another electronic mail related to an email with the stated email header. When a password for an encrypted file is sent to a recipient via an electronic mail, an email having this encrypted file attached thereto and another email containing the password may be associated with each other. Therefore, when email identification information (Message-ID) of an electronic mail from which a password candidate has been extracted is stored, this can make it easier to identify the file that requires this password candidate for decryption.

The electronic mail decrypting device 100 includes a password estimating unit 107. The password estimating unit 107 corresponds to the password estimating unit 4 illustrated in FIG. 1. The password estimating unit 107 estimates a password to be used to decrypt an encrypted email stored in the encrypted email storing unit 110. In other words, the password estimating unit 107 estimates a password to be used to decrypt an encrypted file attached to an electronic mail. The password estimating unit 107 estimates a password for a file attached to an encrypted email based on the attribute information of the encrypted email and the password association information stored in the password candidate storing unit 109.

The password estimating unit 107 estimates at least one password for a file to be decrypted through any of the following methods.

For example, the password estimating unit 107 estimates that, of the stored password candidates, the password candidate that has been extracted from an electronic mail having addressee information matching the addressee information of an encrypted email is the password to be used to decrypt a file attached to this encrypted email. Typically, the addressee of a password is often identical to the addressee of a file. Therefore, selecting a password candidate with the aid of the addressee information can increase the possibility of finding a password that can decrypt the file.

Alternatively, for example, the password estimating unit 107 estimates that, of the stored password candidates, the password candidate that has been extracted from an electronic mail having sender information matching the sender information of an encrypted email is the password to be used to decrypt a file attached to this encrypted email. Typically, the sender of a password is often identical to the sender of a file. Therefore, selecting a password candidate with the aid of the sender information can increase the possibility of finding a password that can decrypt the file.

Alternatively, for example, the password estimating unit 107 estimates that, of the stored password candidates, the password candidate that has been extracted from an electronic mail having a receiving time differing from the receiving time of an encrypted email by a predetermined time or less is the password to be used to decrypt a file attached to this encrypted email. In this example, the predetermined time can be set as desired and may be, for example, one hour. Typically, a password and a file are often sent within a small time interval. Therefore, selecting a password candidate with the aid of the receiving times can increase the possibility of finding a password that can decrypt the file.

Alternatively, for example, the password estimating unit 107 estimates that, of the stored password candidates, the password candidate whose appearance frequency satisfies a predetermined condition is the password to be used to decrypt a file attached to an encrypted email. Specifically, the password estimating unit 107 may estimate, for example, that the password candidate with the lowest appearance frequency is the password to be used to decrypt the file or that the password candidate whose appearance frequency is no higher than a threshold is the password to be used to decrypt the file. Typically, a character string used as a password is a character string that is not used frequently. Therefore, selecting a password candidate with the aid of the appearance frequency can increase the possibility of finding a password that can decrypt the file.

Alternatively, for example, the password estimating unit 107 estimates that, of the stored password candidates, the password candidate extracted from an electronic mail identified by the email identification information (Message-ID) included in the email header of an encrypted email is the password for this encrypted email. As described above, an encrypted email and an email containing a password may be associated with each other. Therefore, selecting a password candidate with the aid of the email identification information can increase the possibility of finding a password that can decrypt the file.

It is needless to say that the password estimating unit 107 may select a password candidate through a combination of the aids described above.

The password estimating unit 107 may estimate a password by selecting a password candidate based on the decryption success record. In other words, the password estimating unit 107 may estimate that, of the stored password candidates, the password candidate that has succeeded in carrying out decryption in the past is the password to be used to decrypt the file.

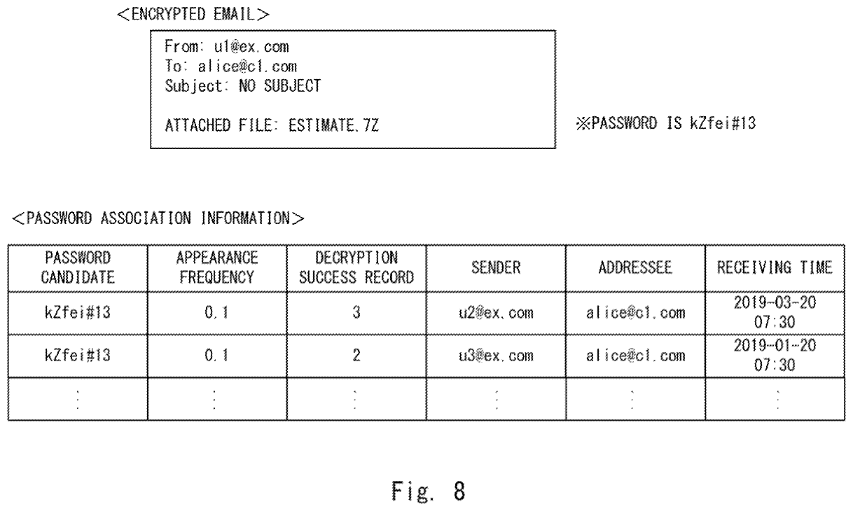

FIG. 8 is an illustration for describing how a password is estimated based on a success record. In the example illustrated in FIG. 8, with regard to the character string “kZfei#13” serving as a password candidate, although the sender in the password association information fails to match the sender of an encrypted email, the character string “kZfei#13” has succeeded in carrying out decryption in the past. Therefore, the character string “kZfei#13” is estimated to be the password for this encrypted email. In the example illustrated in FIG. 8, with regard to the character string “kZfei#13” serving as a password candidate, the addressee in the password association information matches the addressee of an encrypted email. However, even in a case where these addressees fail to match each other, a password may be estimated based on such success record as described above.

When files are exchanged between certain groups or certain organizations, a shared password may be used. In that case, the sender and addressee pair may differ each time a file is sent, and thus estimating a password based on the attribute information of an electronic mail may not yield an appropriate password. Even in such a case, estimating a password based on the decryption success record makes it possible to obtain an appropriate password.

The password estimating unit 107 may correct, of the stored password candidates, the password candidate that has succeeded in carrying out decryption in the past based on the attribute information of an encrypted email and estimate that this corrected password candidate is the password to be used to decrypt a file attached to this encrypted email. For example, the password estimating unit 107 corrects a character string serving as a password candidate as described below. When a password candidate that has succeeded in carrying out decryption in the past includes attribute information of the electronic mail from which this password candidate has been extracted, the password estimating unit 107 corrects this password candidate by replacing the attribute information included in this password candidate with attribute information corresponding to an encrypted email.

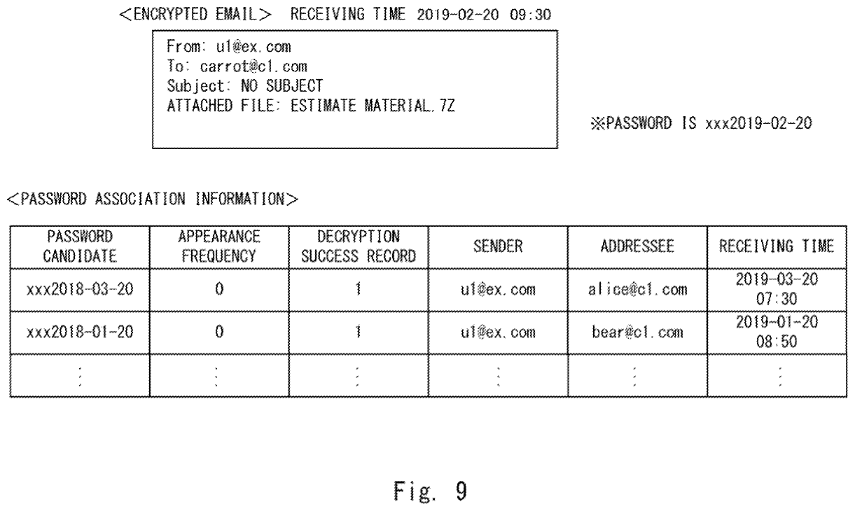

FIG. 9 is an illustration for describing how a password is estimated with a correction made on a stored password candidate. In the example illustrated in FIG. 9, the password candidate “xxx2018-03-20” and the password candidate “xxx2018-01-20” each include attribute information of the electronic mail from which the password candidate has been extracted. To be more specific, the password candidates each include information that is a part of the receiving time (“2018-03-20,” “2018-01-20”). In this case, the password estimating unit 107 generates a password by replacing the attribute information in the character string of the password candidate with the attribute information of an encrypted email (specifically, “2019-02-20” representing information that is a part of the receiving time). In the example illustrated in FIG. 9, the password for the encrypted email is generated from the password candidate extracted from an electronic mail containing, as its attribute information, addressee information matching the addressee information of the encrypted email, but these two pieces of addressee information do not have to match each other. Alternatively, a password for an encrypted email may be generated from a password candidate extracted from an electronic mail containing, as its attribute information, sender information matching the sender information of the encrypted email.

In this manner, when the password estimating unit 107 generates a password by correcting a password candidate, this can increase the possibility of obtaining a password that can appropriately decrypt an encrypted file.

The electronic mail decrypting device 100 includes an encrypted email decryption processing unit 108. The encrypted email decryption processing unit 108 corresponds to the decryption processing unit 5 illustrated in FIG. 1. The encrypted email decryption processing unit 108 performs a process of decrypting a file attached to an encrypted email by use of a password estimated by the password estimating unit 107. The encrypted email decryption processing unit 108 attempts to decrypt an encrypted email stored in the encrypted email storing unit 110 by applying a password estimated by the password estimating unit 107.

Upon succeeding in decryption, the encrypted email decryption processing unit 108 stores data obtained as a result of the decryption into the encrypted email storing unit 110 for cooperation with the email delivery processing unit 104. The email delivery processing unit 104 acquires, from the encrypted email storing unit 110, an electronic mail having a decrypted file attached thereto and delivers this electronic mail to its addressee.

Now, a hardware configuration of the electronic mail decrypting device 100 will be described.

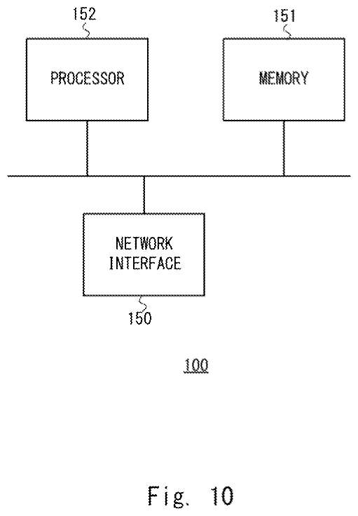

FIG. 10 is a schematic diagram illustrating an example of a hardware configuration of the electronic mail decrypting device 100. As illustrated in FIG. 10, the electronic mail decrypting device 100 includes a network interface 150, a memory 151, and a processor 152.

The network interface 150 is used to communicate with another device. According to the present example embodiment, the network interface 150 is used to send and receive electronic mails.

The memory 151 is constituted, for example, by a combination of a volatile memory and a non-volatile memory. The memory 151 is used to store, for example but not limited to, software (a computer program) that is to be executed by the processor 152 and includes one or more instructions as well as data to be used in various processes of the electronic mail decrypting device 100.

As described above, the electronic mail decrypting device 100 includes, as storage units, the password candidate storing unit 109 that stores password association information and the encrypted email storing unit 110 that stores encrypted emails. These storage units are implemented by storage devices, such as the memory 151, for example. Alternatively, the password candidate storing unit 109 and the encrypted email storing unit 110 may be implemented by different kinds of storage devices other than the memory 151.

The processor 152 reads out software (a computer program) from the memory 151 and executes the software to perform a process of each element illustrated in FIG. 3. The processor 152 may be, for example but not limited to, a microprocessor, a micro processing unit (MPU), or a central processing unit (CPU). The processor 152 may include a plurality of processors.

In this manner, the electronic mail decrypting device 100 is equipped with a function of a computer.

The program described above can be stored and supplied to a computer by use of various types of non-transitory computer-readable media. Such non-transitory computer-readable media include various types of tangible storage media. Examples of non-transitory computer-readable media include a magnetic recording medium (e.g., a flexible disk, a magnetic tape, a hard-disk drive), a magneto-optical recording medium (e.g., a magneto-optical disk), a CD-ROM (read-only memory), a CD-R, a CD-R/W, and a semiconductor memory (e.g., a mask ROM, a programmable ROM (PROM), an erasable PROM (EPROM), a flash ROM, a random-access memory (RAM)). The program may also be supplied to a computer by use of various types of transitory computer-readable media. Examples of such transitory computer-readable media include an electric signal, an optical signal, and an electromagnetic wave. A transitory computer-readable medium can supply the program to a computer via a wired communication line, such as an electric wire or an optical fiber, or via a wireless communication line.

Now, an operation of the electronic mail decrypting device 100 will be described.

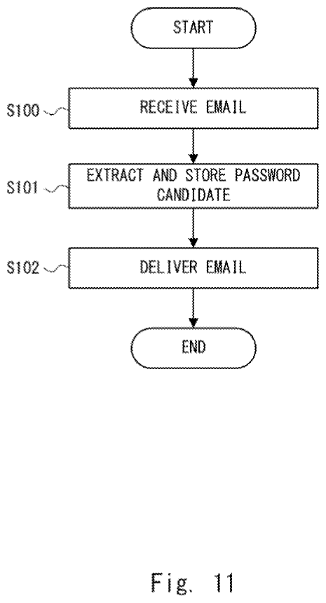

FIG. 11 is a flowchart for describing a flow of an operation performed when the electronic mail decrypting device 100 extracts a password candidate from an electronic mail. The flow of the operation will be described below following the flowchart illustrated in FIG. 11.

At step S100 (S100), a sender sends an email, and the email reception processing unit 101 receives this email.

Next, at step S101 (S101), the password candidate extracting unit 102 scans the text body of the electronic mail received at step S100 and extracts a character string to serve as a password candidate. Then, the password candidate storing processing unit 106 performs a process of storing, into the password candidate storing unit 109, the extracted password candidate and attribute information of the electronic mail from which this password candidate has been extracted with the extracted password candidate and the attribute information associated with each other. At this point, the appearance frequency calculating unit 105 may calculate the appearance frequency. In that case, the password candidate storing processing unit 106 performs a process of storing the password candidate and the appearance frequency into the password candidate storing unit 109 with the password candidate and the appearance frequency associated with each other.

Next, at step S102 (S102), the email delivery processing unit 104 delivers the email received at step S100 to the addressee of this email.

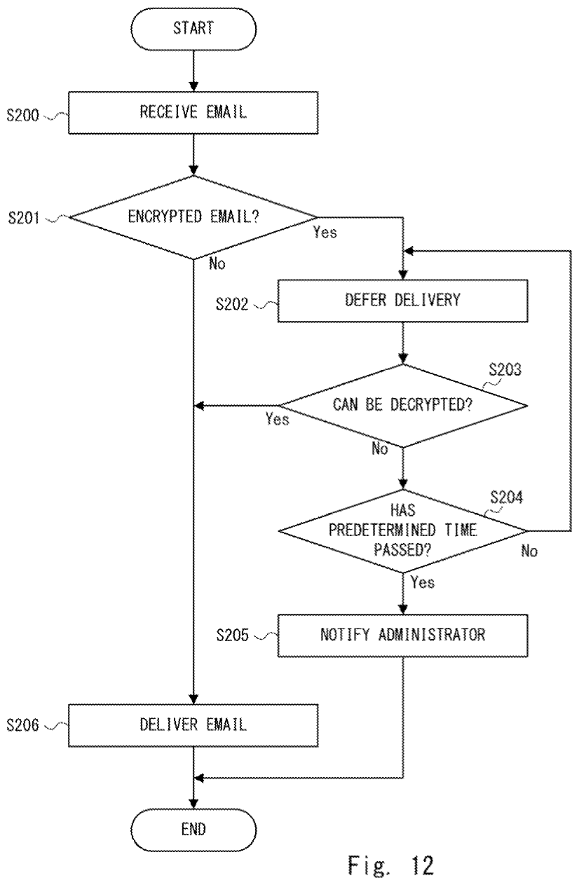

FIG. 12 is a flowchart for describing a flow of an operation performed when the electronic mail decrypting device 100 decrypts an encrypted email. The flow of the operation will be described below following the flowchart illustrated in FIG. 12.

At step S200 (S200), a sender sends an email, and the email reception processing unit 101 receives this email.

Next, at step S201, (S201), the encrypted email determining unit 103 determines whether the email received at step S200 is an encrypted email. If the received email is an encrypted email, the process moves to step S202. If the received email is not an encrypted email, the process moves to step S206, and the email is delivered by the email delivery processing unit 104.

At step S202 (S202), the encrypted email determining unit 103 stores the email determined to be an encrypted email into the encrypted email storing unit 110, and the email delivery processing unit 104 defers the delivery of this email.

After step S202, at step S203 (S203), an attempt is made to decrypt the encrypted email stored in the encrypted email storing unit 110. Specifically, at this step, the password estimating unit 107 estimates a password, and the encrypted email decryption processing unit 108 attempts to decrypt the encrypted email. The encrypted email decryption processing unit 108 successively attempts passwords estimated by the password estimating unit 107. In the attempt to decrypt the encrypted email, a password estimated with the aids described above is used preferentially, and also a decryption attempt may be made by use of a password candidate that does not satisfy the condition pertaining to the aids. If the encrypted email has been decrypted successfully, the password candidate storing processing unit 106 stores the success record for the password candidate that has succeeded in carrying out decryption into the password candidate storing unit 109, and the process moves to step S206. In contrast, if the encrypted email fails to be decrypted, the process moves to step S204.

At step S204 (S204), the encrypted email decryption processing unit 108 determines whether a predetermined time (e.g., one day) has passed since the receiving time of the encrypted email that has failed to be decrypted. If the predetermined time has not passed (No at step S204), the delivery is deferred, and the encrypted email decryption processing unit 108 attempts to decrypt this encrypted email again after a predetermined time. In contrast, if the predetermined time has passed (Yes at step S204), the process moves to step S205.

At step S205 (S205), since the decryption remains unsuccessful for a predetermined time, the encrypted email decryption processing unit 108 prompts an administrator to take action. As error processing, aside from prompting the administrator, other processes may be performed. For example, a notification email may be sent to the sender of the encrypted email that has failed to be decrypted, and then this encrypted email may be discarded.

Meanwhile, if the encrypted email has been decrypted successfully, at step S206 (S206), the email delivery processing unit 104 delivers the decrypted email to the addressee of this email. Specifically, the email delivery processing unit 104 replaces the encrypted file originally attached to the received encrypted email with the decrypted file and delivers the resulting email to its addressee.

Thus far, the first example embodiment has been described. With the electronic mail decrypting device 100 according to the present example embodiment, a password candidate is extracted from an electronic mail, and password association information is stored into the password candidate storing unit 109. Then, an encrypted email is decrypted with a password estimated based on the password association information. This configuration renders it unnecessary to set passwords associated with senders or recipients in a system in advance. In addition, this configuration places no constraint on the sequential relationship between the reception of an encrypted email and the reception of a password for decrypting the encrypted email. In other words, an encrypted email can be decrypted even when the encrypted email is sent after an email containing a password has been sent. In this manner, the electronic mail decrypting device 100 makes it possible to decrypt an encrypted email with reduced operational constraints.

### Second Example Embodiment

Now, a second example embodiment will be described.

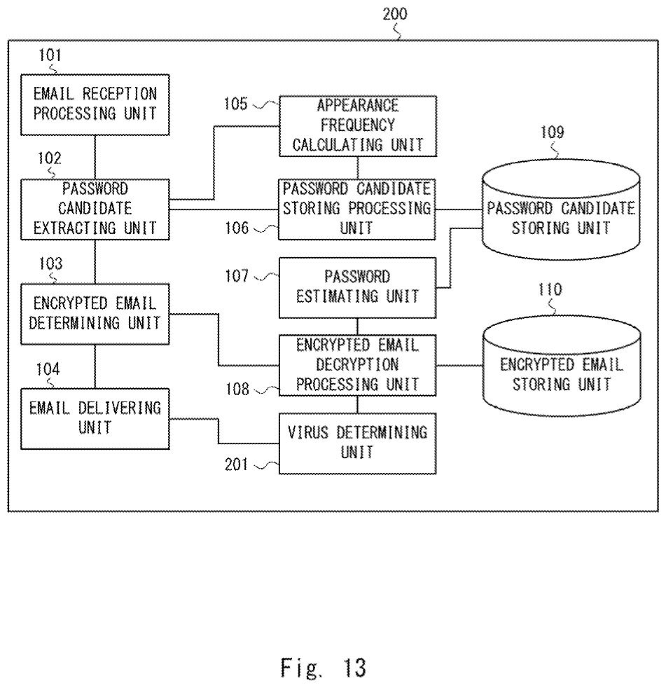

FIG. 13 is a block diagram illustrating an example of a configuration of an electronic mail decrypting device 200 according to the second example embodiment. The electronic mail decrypting device 200 differs from the electronic mail decrypting device 100 according to the first example embodiment illustrated in FIG. 3 in that the electronic mail decrypting device 200 further includes a virus determining unit 201.

The process of each element illustrated in FIG. 13 is implemented, for example, as the processor 152 reads out software (a computer program) from the memory 151 and executes the software.

In the following, the electronic mail decrypting device 200 according to the second example embodiment will be described with the description of the components and processes that is repetitive of the first example embodiment omitted, as appropriate.

The virus determining unit 201 determines whether a file decrypted by the encrypted email decryption processing unit 108 contains a virus. The virus determining unit 201 determines the presence or absence of a virus through a known virus detection technique.

The email delivery processing unit 104 according to the present example embodiment delivers an encrypted email if the decrypted file contains no virus. Specifically, if the decrypted file contains no virus, the email delivery processing unit 104 delivers an encrypted email having this file attached thereto to the addressee of this electronic mail with the encrypted file replaced by the decrypted file. In contrast, if the decrypted file contains a virus, the email delivery processing unit 104 refrains from delivering the encrypted email having this file attached thereto.

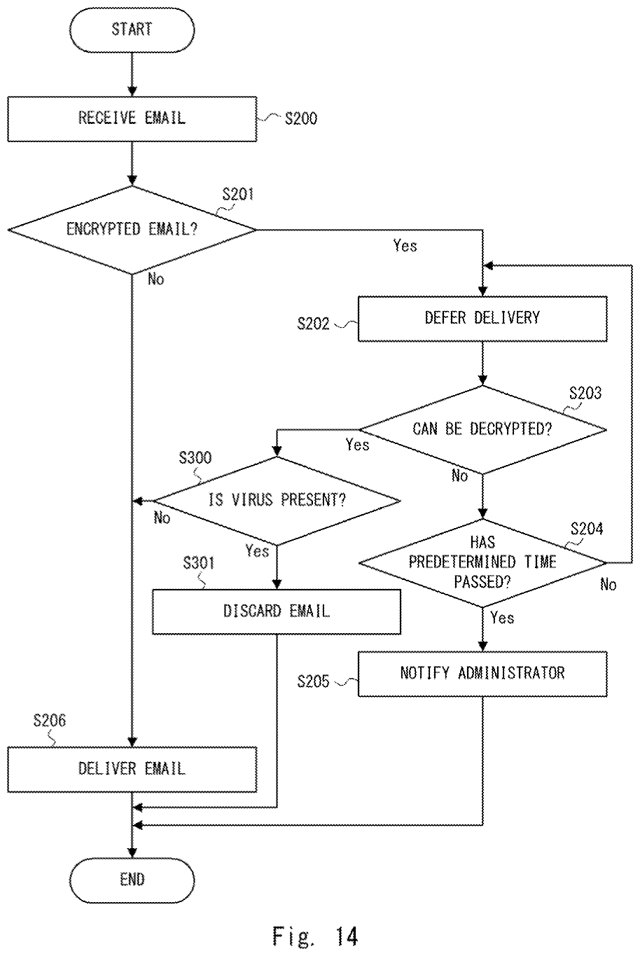

FIG. 14 is a flowchart for describing a flow of an operation performed when the electronic mail decrypting device 200 according to the second example embodiment decrypts an encrypted email. The flowchart illustrated in FIG. 14 differs from the flowchart illustrated in FIG. 12 in that step S300 and step S301 are added.

According to the present example embodiment, if the encrypted email has been decrypted successfully (Yes at step S203), the process moves to step S300.

At step S300 (S300), the virus determining unit 201 determines whether the decrypted file contains a virus. If the decrypted file contains no virus (No at step S300), the process moves to step S206, and the email is delivered. In contrast, if the decrypted file contains a virus (Yes at step S300), the process moves to step S301.

At step S301 (S301), the virus determining unit 201 discards the electronic mail having the virus-containing file attached thereto. In this example, the virus determining unit 201 may also perform other error processing, such as notifying an administrator.

Thus far, the second example embodiment has been described. According to the present example embodiment, the presence or absence of any virus is determined, and the delivery of an email containing a virus is stopped. Accordingly, a more secure system can be constructed.

### Third Example Embodiment

Now, a third example embodiment will be described.

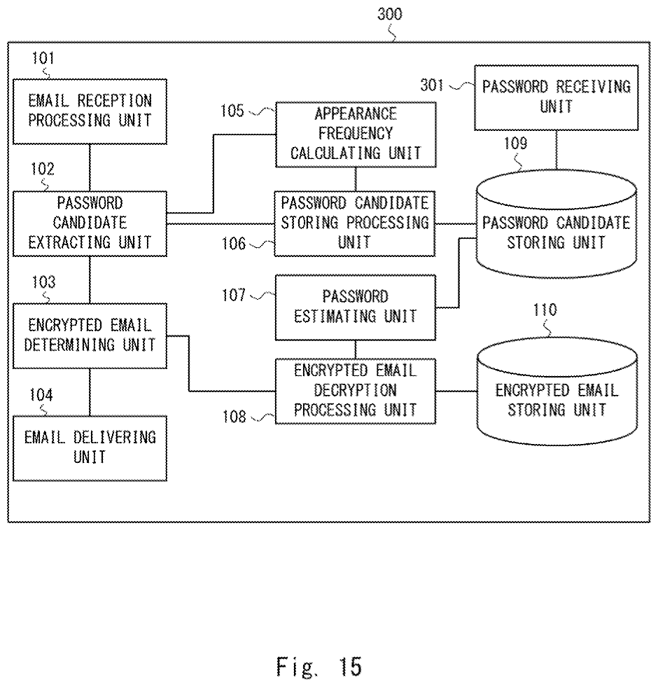

FIG. 15 is a block diagram illustrating an example of a configuration of an electronic mail decrypting device 300 according to the third example embodiment. The electronic mail decrypting device 300 differs from the electronic mail decrypting device 100 according to the first example embodiment illustrated in FIG. 3 in that the electronic mail decrypting device 300 further includes a password receiving unit 301.

The process of each element illustrated in FIG. 15 is implemented, for example, as the processor 152 reads out software (a computer program) from the memory 151 and executes the software.

In the following, the electronic mail decrypting device 300 according to the third example embodiment will be described with the description of the components and processes that is repetitive of the first example embodiment omitted, as appropriate.

The password receiving unit 301 receives input of sender information and a password. Specifically, the password receiving unit 301 receives input of sender information and a password that the user inputs via an input device (not illustrated).

The password receiving unit 301 receives input of sender information and a password, for example, as follows. The password receiving unit 301 has the user input his or her email address and authenticates the user by this email address. If the authentication is successful, the password receiving unit 301 has this user input a password. Thus, the password receiving unit 301 receives the sender information (the email address used for authentication) and the password. In this example, the sender information to be received does not have to be the email address used for authentication. Moreover, the authentication may be performed by use of different kind of information other than the email address.

The password candidate storing processing unit 106 according to the present example embodiment performs a process of storing sender information and a password received by the password receiving unit 301 into the password candidate storing unit 109 with the sender information and the password associated with each other.

The password estimating unit 107 according to the present example embodiment preferentially uses the password received by the password receiving unit 301. In this case, the password estimating unit 107 selects a password based on the sender information. Specifically, the password estimating unit 107 estimates that, of the stored passwords, the password having associated sender information matching the sender information of an encrypted email is the password to be used to decrypt the file.

In this example, the password receiving unit 301 may receive input of addressee information and a password, instead of sender information and a password. Specifically, the password receiving unit 301 may receive input of addressee information and a password that the user inputs via an input device (not illustrated).

The password receiving unit 301 receives input of addressee information and a password, for example, as follows. The password receiving unit 301 has the user input his or her email address and authenticates the user by this email address. If the authentication is successful, the password receiving unit 301 has this user input a password. Thus, the password receiving unit 301 receives the addressee information (the email address used for authentication) and the password. In this example, the addressee information to be received does not have to be the email address used for authentication. Moreover, the authentication may be performed by use of different kind of information other than the email address.

In this case, the password candidate storing processing unit 106 performs a process of storing addressee information and a password received by the password receiving unit 301 into the password candidate storing unit 109 with the addressee information and the password associated with each other. Then, the password estimating unit 107 estimates that, of the stored passwords, the password having associated addressee information matching the addressee information of an encrypted email is the password to be used to decrypt the file.

In this example, the password receiving unit 301 may receive a password before the decrypting process or receive input of a password if decryption with a password candidate extracted from an electronic mail has failed. In this case, for example, the password receiving unit 301 may send an inquiry email to the sender or the recipient of the encrypted email that has failed to be decrypted and have the user input a password via a web screen or the like, for example.

Thus far, the third example embodiment has been described. According to the present example embodiment, input of a password can be received from the user. Therefore, an encrypted email can be decrypted even when no password is included in an electronic mail.

The present invention is not limited to the example embodiments described above, and modifications can be made, as appropriate, within the scope that does not depart from the technical spirit.

For example, an electronic mail decrypting device that includes both the virus determining unit 201 according to the second example embodiment and the password receiving unit 301 according to the third example embodiment can also be constructed.

According to the foregoing example embodiments, an encrypted email is decrypted, and then the email delivery processing unit 104 delivers the decrypted email. Alternatively, the email delivery processing unit 104 may deliver an email that has not been decrypted (i.e., an email that is still encrypted).

A part or the whole of the foregoing example embodiments can also be expressed as in the following supplementary notes, which are not limiting.

### (Supplementary Note 1)

An electronic mail decrypting device comprising:

password candidate extracting means configured to extract a character string to serve as a password candidate from a text body of an electronic mail;

storing processing means configured to perform a process of storing the password candidate and attribute information of the electronic mail from which the password candidate has been extracted with the password candidate and the attribute information associated with each other;

password estimating means configured to estimate a password to be used to decrypt an encrypted file based on attribute information of an electronic mail having the encrypted file attached thereto as well as the stored password candidate and the stored attribute information of the electronic mail from which the password candidate has been extracted; and

decryption processing means configured to perform a process of decrypting the file by use of the estimated password.

### (Supplementary Note 2)

The electronic mail decrypting device according to Supplementary note 1, wherein

the attribute information includes addressee information of the electronic mail, and

the password estimating means is configured to estimate that, of the stored password candidates, the password candidate that has been extracted from an electronic mail having addressee information matching addressee information of the electronic mail having the file attached thereto is a password to be used to decrypt the file.

### (Supplementary Note 3)

The electronic mail decrypting device according to Supplementary note 1 or 2, wherein

the attribute information includes sender information of the electronic mail, and

the password estimating means is configured to estimate that, of the stored password candidates, the password candidate that has been extracted from the electronic mail having sender information matching sender information of the electronic mail having the file attached thereto is a password to be used to decrypt the file.

### (Supplementary Note 4)

The electronic mail decrypting device according to any one of Supplementary notes 1 to 3, wherein

the attribute information includes receiving time of the electronic mail, and

the password estimating means is configured to estimate that, of the stored password candidates, the password candidate that has been extracted from the electronic mail having a receiving time that differs from a receiving time of the electronic mail having the file attached thereto by a predetermined time or less is a password to be used to decrypt the file.

### (Supplementary Note 5)

The electronic mail decrypting device according to any one of Supplementary notes 1 to 4, further comprising appearance frequency calculating means configured to calculate an appearance frequency of each of the password candidates, wherein

the storing processing means is configured to perform a process of further associating the appearance frequency with the password candidate and storing the appearance frequency and the password candidate, and

the password estimating means is configured to estimate that, of the stored password candidates, the password candidate of which the appearance frequency satisfies a predetermined condition is a password to be used to decrypt the file.

### (Supplementary Note 6)

The electronic mail decrypting device according to any one of Supplementary notes 1 to 5, wherein the password estimating means is configured to estimate that, of the stored password candidates, the password candidate extracted from the electronic mail identified by email identification information included in an email header of the electronic mail having the file attached thereto is a password to be used to decrypt the file.

### (Supplementary Note 7)

The electronic mail decrypting device according to any one of Supplementary notes 1 to 6, wherein

the storing processing means is configured to perform a process of further associating a success record of decryption involving the password candidate with the password candidate and storing the success record and the password candidate, and

the password estimating means is configured to estimate that, of the stored password candidates, the password candidate that has succeeded in carrying out decryption is a password to be used to decrypt the file.

### (Supplementary Note 8)

The electronic mail decrypting device according to any one of Supplementary notes 1 to 7, wherein

the storing processing means is configured to perform a process of further associating a success record of decryption involving the password candidate with the password candidate and storing the success record and the password candidate, and

the password estimating means is configured to correct, of the stored password candidates, the password candidate that has succeeded in carrying out decryption based on the attribute information of the electronic mail having the file attached thereto and to estimate that the corrected password candidate is a password to be used to decrypt the file.

(Supplementary note 9)

The electronic mail decrypting device according to any one of Supplementary notes 1 to 8, further comprising:

virus determining means configured to determine whether the decrypted file contains a virus; and

regarding the electronic mail having the encrypted file attached thereto, email delivery processing means configured to deliver the electronic mail to an addressee of the electronic mail in which the encrypted file attached thereto is replaced by the decrypted file, if the file contains no virus.

### (Supplementary Note 10)

The electronic mail decrypting device according to any one of Supplementary notes 1 to 9, further comprising password receiving means configured to receive input of sender information or addressee information and a password, wherein

the storing processing means is further configured to perform a process of storing the received sender information or the received addressee information and the password with the sender information or the addressee information and the password associated with each other, and

the password estimating means is configured to estimate that, of the stored passwords, the password having the associated sender information or the associated addressee information matching the sender information or the addressee information of an electronic mail having an encrypted file attached thereto is a password to be used to decrypt the file.

### (Supplementary Note 11)

An electronic mail decrypting method comprising:

extracting a character string to serve as a password candidate from a text body of an electronic mail;

performing a process of storing the password candidate and attribute information of the electronic mail from which the password candidate has been extracted with the password candidate and the attribute information associated with each other;

estimating a password to be used to decrypt an encrypted file based on attribute information of an electronic mail having the encrypted file attached thereto as well as the stored password candidate and the stored attribute information of the electronic mail from which the password candidate has been extracted; and

performing a process of decrypting the file by use of the estimated password.

### (Supplementary Note 12)

A non-transitory computer-readable medium storing a program that causes a computer to execute:

a password candidate extracting step of extracting a character string to serve as a password candidate from a text body of an electronic mail;

a storing processing step of performing a process of storing the password candidate and attribute information of the electronic mail from which the password candidate has been extracted with the password candidate and the attribute information associated with each other;

a password estimating step of estimating a password to be used to decrypt an encrypted file based on attribute information of an electronic mail having the encrypted file attached thereto as well as the stored password candidate and the stored attribute information of the electronic mail from which the password candidate has been extracted; and

a decryption processing step of performing a process of decrypting the file by use of the estimated password.

Thus far, the invention of the present application has been described with reference to the example embodiments, but the invention of the present application is not limited by the foregoing example embodiments. Various modifications that a person skilled in the art can appreciate can be made to the configurations and the details of the invention of the present application within the scope of the invention.

This application claims priority to Japanese Patent Application No. 2019-169336, filed on Sep. 18, 2019, the entire disclosure of which is incorporated herein.

### REFERENCE SIGNS LIST

1 electronic mail decrypting device
2 password candidate extracting unit
3 storing processing unit
4 password estimating unit
5 decryption processing unit
100 electronic mail decrypting device
101 email reception processing unit
102 password candidate extracting unit
103 encrypted email determining unit
104 email delivery processing unit
105 appearance frequency calculating unit
106 password candidate storing processing unit
107 password estimating unit
108 encrypted email decryption processing unit
109 password candidate storing unit
110 encrypted email storing unit
150 network interface
151 memory
152 processor
200 electronic mail decrypting device
201 virus determining unit
300 electronic mail decrypting device
301 password receiving unit

What is claimed is:

1. An electronic mail decrypting device comprising:
at least one memory storing program instructions; and
at least one processor configured to execute the instructions stored in the memory to:
extract a character string to serve as a password candidate from a text body of an electronic mail;
perform a process of storing the password candidate and attribute information of the electronic mail from which the password candidate has been extracted with the password candidate and the attribute information associated with each other;
estimate a password to be used to decrypt an encrypted file based on attribute information of an electronic mail having the encrypted file attached thereto as well as the stored password candidate and the stored attribute information of the electronic mail from which the password candidate has been extracted; and
perform a process of decrypting the file by use of the estimated password.

2. The electronic mail decrypting device according to claim 1, wherein
the attribute information includes addressee information of the electronic mail, and
the processor is further configured to execute the instructions to estimate that, of the stored password candidates, the password candidate that has been extracted from an electronic mail having addressee information matching addressee information of the electronic mail having the file attached thereto is a password to be used to decrypt the file.

3. The electronic mail decrypting device according to claim 1, wherein
the attribute information includes sender information of the electronic mail, and
the processor is further configured to execute the instructions to estimate that, of the stored password candidates, the password candidate that has been extracted from the electronic mail having sender information matching sender information of the electronic mail having the file attached thereto is a password to be used to decrypt the file.

4. The electronic mail decrypting device according to claim 1, wherein
the attribute information includes receiving time of the electronic mail, and
the processor is further configured to execute the instructions to estimate that, of the stored password candidates, the password candidate that has been extracted from the electronic mail having a receiving time that differs from a receiving time of the electronic mail having the file attached thereto by a predetermined time or less is a password to be used to decrypt the file.

5. The electronic mail decrypting device according to claim 1, wherein
the processor is further configured to execute the instructions to:
calculate an appearance frequency of each of the password candidates,
perform a process of further associating the appearance frequency with the password candidate and storing the appearance frequency and the password candidate, and
estimate that, of the stored password candidates, the password candidate of which the appearance frequency satisfies a predetermined condition is a password to be used to decrypt the file.

6. The electronic mail decrypting device according to claim 1, wherein the processor is further configured to execute the instructions to estimate that, of the stored password candidates, the password candidate extracted from the electronic mail identified by email identification information included in an email header of the electronic mail having the file attached thereto is a password to be used to decrypt the file.

7. The electronic mail decrypting device according to claim 1, wherein
the processor is further configured to execute the instructions to:
perform a process of further associating a success record of decryption involving the password candidate with the password candidate and storing the success record and the password candidate, and
estimate that, of the stored password candidates, the password candidate that has succeeded in carrying out decryption is a password to be used to decrypt the file.

8. The electronic mail decrypting device according to claim 1, wherein
the processor is further configured to execute the instructions to:
perform a process of further associating a success record of decryption involving the password candidate with the password candidate and storing the success record and the password candidate,
correct, of the stored password candidates, the password candidate that has succeeded in carrying out decryption based on the attribute information of the electronic mail having the file attached thereto, and
estimate that the corrected password candidate is a password to be used to decrypt the file.

9. The electronic mail decrypting device according to claim 1, wherein
the processor is further configured to execute the instructions to:
determine whether the decrypted file contains a virus; and
regarding the electronic mail having the encrypted file attached thereto, deliver the electronic mail to an addressee of the electronic mail in which the encrypted file attached thereto is replaced by the decrypted file, if the file contains no virus.

10. The electronic mail decrypting device according to claim 1, wherein
the processor is further configured to execute the instructions to:
receive input of sender information or addressee information and a password,
perform a process of storing the received sender information or the received addressee information and the password with the sender information or the addressee information and the password associated with each other, and
estimate that, of the stored passwords, the password having the associated sender information or the associated addressee information matching the sender information or the addressee information of an electronic mail having an encrypted file attached thereto is a password to be used to decrypt the file.

11. An electronic mail decrypting method comprising:
extracting a character string to serve as a password candidate from a text body of an electronic mail;
performing a process of storing the password candidate and attribute information of the electronic mail from which the password candidate has been extracted with the password candidate and the attribute information associated with each other;
estimating a password to be used to decrypt an encrypted file based on attribute information of an electronic mail having the encrypted file attached thereto as well as the stored password candidate and the stored attribute information of the electronic mail from which the password candidate has been extracted; and
performing a process of decrypting the file by use of the estimated password.

12. A non-transitory computer-readable medium storing a program that causes a computer to execute:
a password candidate extracting step of extracting a character string to serve as a password candidate from a text body of an electronic mail;
a storing processing step of performing a process of storing the password candidate and attribute information of the electronic mail from which the password candidate has been extracted with the password candidate and the attribute information associated with each other;
a password estimating step of estimating a password to be used to decrypt an encrypted file based on attribute information of an electronic mail having the encrypted file attached thereto as well as the stored password candidate and the stored attribute information of the electronic mail from which the password candidate has been extracted; and
a decryption processing step of performing a process of decrypting the file by use of the estimated password.
